(19) United States
(12) Patent Application Publication
(10) Pub. No.: US 2020/0236612 A1
(43) Pub. Date: Jul. 23, 2020

(54) ACCESS METHOD AND DEVICE, USER EQUIPMENT AND BASE STATION

(71) Applicant: BEIJING XIAOMI MOBILE SOFTWARE CO., LTD., Beijing (CN)

(72) Inventor: Wei HONG, Beijing (CN)

(73) Assignee: BEIJING XIAOMI MOBILE SOFTWARE CO., LTD., Beijing (CN)

(21) Appl. No.: 16/840,348

(22) Filed: Apr. 4, 2020

Related U.S. Application Data
(63) Continuation of application No. PCT/CN2017/107006, filed on Oct. 20, 2017.

(51) Int. Cl. H04W 48/10; H04W 48/18

(52) U.S. Cl. CPC H04W 48/10; H04W 48/18

(57) ABSTRACT

An access method includes: monitoring a first signaling broadcast by a base station; reading from the first signaling a corresponding Public Land Mobile Network (PLMN) list and a cell barred indicating bit corresponding to the PLMN list on the basis of a core network connection; and determining, on the basis of the value of the cell barred indicating bit, whether to access a PLMN in the PLMN list. The method can solve a problem in a situation where the next generation base station of LTE is shared by a plurality of radio access networks, and user equipment only supporting a first core network attempt to access a base station only connected to a second core network, thereby increasing success rate of the user equipment to access a network.

### CROSS-REFERENCE TO RELATED APPLICATION

This is a continuation of International Patent Application No. PCT/CN2017/107006 filed on Oct. 20, 2017, the disclosure of which is hereby incorporated by reference in its entirety.

### BACKGROUND

In related art, for making 5th Generation (5G) commercial more rapidly, the 3rd Generation Partnership Project (3GPP) approves preferential standardization of a Non-StandAlone (NSA) scenario, and further conducts researches on a scenario that a next-generation Long Term Evolution (LTE) base station accesses a 5G core network.

### SUMMARY

The present disclosure relates generally to the technical field of communications, and more specifically to an access method and device, User Equipment (UE), and a base station.

Various embodiments of the present disclosure provide an access method and device, UE and a base station, in order to solve the problem that UE only supporting a first core network connection tries to access a base station only connected with a second core network in a scenario that a next-generation LTE base station is shared by multiple radio access networks, and thus to increase the success rate of access of the UE to a network.

According to a first aspect of the embodiments of the present disclosure, an access method is provided, which may be applied to UE and include that:
a first signaling broadcast by a base station is monitored;
a Public Land Mobile Network (PLMN) list and a cell-barred indicator bit corresponding to the PLMN list are read from the first signaling based on a supporting capability for core network connection; and
whether to access a PLMN in the PLMN list is determined based on a value of the cell-barred indicator bit.

According to a second aspect of the embodiments of the present disclosure, an access method is provided, which may be applied to a base station and include that:
at least one PLMN list to be broadcast and a cell-barred indicator bit corresponding to each of the at least one PLMN list to be broadcast are determined based on a supporting capability of each operator network for core network connection; and
a first signaling including the at least one PLMN list to be broadcast is sent.

According to a third aspect of the embodiments of the present disclosure, an access device is provided, which may be applied to UE and include:
a monitoring module, configured to monitor a first signaling broadcast by a base station;
a reading module, configured to read a corresponding PLMN list and a cell-barred indicator bit corresponding to the PLMN list from the first signaling monitored by the monitoring module based on a supporting capability for core network connection; and
a first determination module, configured to determine whether to access a PLMN in the PLMN list based on a value of the cell-barred indicator bit read by the reading module.

According to a fourth aspect of the embodiments of the present disclosure, an access device is provided, which may be applied to a base station and include:
a second determination module, configured to determine at least one PLMN list to be broadcast and a cell-barred indicator bit corresponding to each of the at least one PLMN list to be broadcast based on a supporting capability of each operator network for core network connection; and
a sending module, configured to send a first signaling including the at least one PLMN list to be broadcast.

According to a fifth aspect of the embodiments of the present disclosure, UE is provided, which may include:
a processor; and
a memory configured to store instructions executable by the processor,
wherein the processor may be configured to:
monitor a first signaling broadcast by a base station;
read from the first signaling a PLMN list and a cell-barred indicator bit corresponding to the PLMN list based on a supporting capability for core network connection; and
determine whether to access a PLMN in the PLMN list based on a value of the cell-barred indicator bit.

According to a sixth aspect of the embodiments of the present disclosure, a base station is provided, which may include:
a processor; and
a memory configured to store instructions executable by the processor,
wherein the processor may be configured to:
determine at least one PLMN list to be broadcast and a cell-barred indicator bit corresponding to each of the at least one PLMN list to be broadcast based on a supporting capability of each operator network for core network connection; and
send a first signaling including the at least one PLMN list to be broadcast.

According to a seventh aspect of the embodiments of the present disclosure, a non-transitory computer-readable storage medium is provided, in which computer instructions may be stored, the instructions, when being executed by a processor, cause the processor to implement the following operations:
a first signaling broadcast by a base station is monitored;
a PLMN list and a cell-barred indicator bit corresponding to the PLMN list are read from the first signaling based on a supporting capability for core network connection; and
whether to access a PLMN in the PLMN list is determined based on a value of the cell-barred indicator bit.

According to an eighth aspect of the embodiments of the present disclosure, a non-transitory computer-readable storage medium is provided, in which computer instructions may be stored, the instructions, when being executed by a processor, cause the processor to implement the following operations:
at least one PLMN list to be broadcast and a cell-barred indicator bit corresponding to each of the at least one PLMN list to be broadcast are determined based on a supporting capability of each operator network for core network connection; and
a first signaling including the at least one PLMN list to be broadcast is sent.

It is to be understood that the above general descriptions and detailed descriptions below are only exemplary and explanatory and not intended to limit the present disclosure.

### BRIEF DESCRIPTION OF THE DRAWINGS

The accompanying drawings referred to in the specification are a part of this disclosure, and provide illustrative embodiments consistent with the disclosure and, together with the detailed description, serve to illustrate some embodiments of the disclosure.

FIG. 1A is a flowchart illustrating an access method according to some embodiments.

FIG. 1B is a diagram of an application scenario of an access method, according to some embodiments of the present disclosure.

FIG. 2 is a flowchart illustrating another access method, according to some embodiments of the present disclosure.

FIG. 3 is a flowchart illustrating another access method, according to some embodiments of the present disclosure.

FIG. 4 is a flowchart illustrating an access method, according to some embodiments of the present disclosure.

FIG. 5 is a flowchart showing another access method, according to an exemplary embodiment.

FIG. 6 is a block diagram of an access device, according to some embodiments of the present disclosure.

FIG. 7 is a block diagram of another access device, according to some embodiments of the present disclosure.

FIG. 8 is a block diagram of an access device, according to some embodiments of the present disclosure.

FIG. 9 is a block diagram of another access device, according to some embodiments of the present disclosure.

FIG. 10 is a block diagram of an access device, according to some embodiments of the present disclosure.

FIG. 11 is a block diagram of an access device, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the present disclosure as recited in the appended claims.

One next-generation LTE base station can be shared by networks of multiple operators and the networks of different operators support access to different core networks. For example, the network of an operator 1 only supports access of the next-generation LTE base station to the 5G core network, and the network of an operator 2 supports access of the next-generation LTE base station to a 4th Generation (4G) core network and/or the 5G core network. As a consequence, when the next-generation LTE base station is shared by the networks of different operators, UE only supporting the 4G core network may try to access a base station only supporting a 5G core network connection, resulting in the problems of access failure, waste of signaling and the like.

For popularizing and standardizing the scenario that a next-generation LTE base station is shared by multiple radio access networks, a solution may be needed for preventing the UE only supporting a 4G core network from accessing a next-generation LTE base station only supporting a 5G core network connection for the scenario that the next-generation LTE base station is shared by the multiple radio access networks.

In some embodiments of the present disclosure, a base station may be a next-generation LTE base station, and the next-generation LTE base station may be understood as a base station that may be connected to a 4G core network and may also be connected to a 5G core network. A first core network connection described in the technical solutions of the present disclosure may be a 4G core network connection, and a second core network connection may be a 5G core network connection or a new-generation core network connection. In addition, the technical solutions of the present disclosure may be applied to a scenario that the next-generation LTE base station is shared by multiple radio access networks. For example, the next-generation LTE base station may be supported by a network of operator 1, a network of operator 2 and a network of operator 3, and the networks of different operators may have different supporting capabilities for the core network connection.

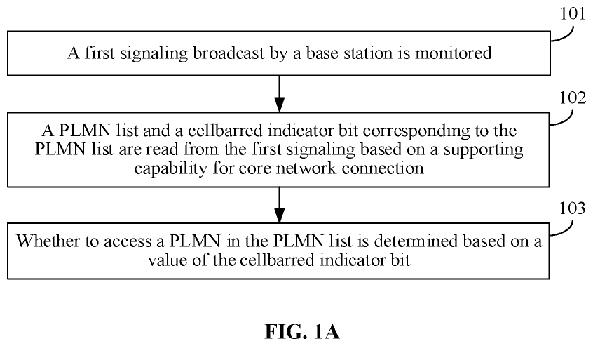

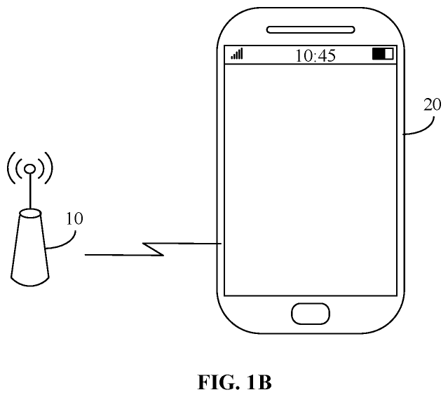

FIG. 1A is a flowchart illustrating an access method according to some embodiments of the present disclosure. FIG. 1B is a diagram of an application scenario of an access method according to some embodiments of the present disclosure. The access method may be applied to UE. As shown in FIG. 1A, the access method includes the following operations 101-103.

In operation 101, a first signaling broadcast by a base station is monitored.

In an embodiment, the first signaling may comprises a signaling formed by adding a PLMN list to be broadcast into an existing system signaling, for example, System Information Block (SIB) signaling. The first signaling may carry a PLMN list formed by a PLMN for indicating a supporting capability for core network connection, for example, carrying a first list formed by a PLMN only supporting a first core network connection and a PLMN supporting both the first core network connection and a second core network connection; and/or, carrying a second list formed by a PLMN only supporting the second core network connection. The first core network connection may be a 4G network connection, and the second core network connection may be a 5G network connection.

In an embodiment, the first signaling further includes a setting for a cell-barred indicator bit corresponding to each PLMN list.

In operation 102, a PLMN list and a cell-barred indicator bit corresponding to the PLMN list are read from the first signaling based on a supporting capability for core network connection.

In an embodiment, the PLMN list, that can be read by the UE, corresponding to the core network connection supporting capability of the UE (i.e., the support capability that the UE supports the core network connection) may be predetermined through a protocol. For example, it may be predetermined through the protocol that UE only supporting a 4G core network connection may only read the first list, and it is predetermined through the protocol that UE supporting a 5G core network connection or supporting both the 4G/5G core network connections may read both the first list and the second list.

In an embodiment, based on the protocol, the UE, when monitoring the first signaling, may read the corresponding PLMN list and a value of the cell-barred indicator bit corresponding to the PLMN list from the first signaling.

In operation 103, whether to access a PLMN in the PLMN list is determined based on a value of the cell-barred indicator bit.

In operation 102 and operation 103, if a base station is shared by a network of an operator 1 (PLMN1), a network of an operator 2 (PLMN2) and a network of an operator 3 (PLMN3), but the network of the operator 1 only supports connection to a 4G core network, the network of the operator 2 only supports connection to a 5G core network and the network of the operator 3 supports connection to both the 4G and 5G core networks, the base station broadcasts the first signaling by containing the PLMN2 in the first list and placing the PLMN1 and the PLMN3 in the second list. If the first signaling is monitored by UE only supporting the 4G core network connection, the UE needs to read the second list in the first signaling after being turned on, and if the cell-barred indicator bit corresponding to the second list is not true, the UE may select to access the required the PLMN1 or PLMN3. If the first signaling is monitored by UE supporting both the 4G and 5G core network connections, the UE may read the first list and the second list after being turned on and select to access a PLMN of which a cell-barred indicator bit is not true.

In an exemplary scenario, as shown in FIG. 1B, a next-generation LTE base station LTEng-eNB 10 and UE 30 are deployed in the scenario that the next-generation LTE base station is shared by multiple radio access networks. The next-generation LTE base station 10 is shared by multiple radio access networks, and the UE 20, after being turned on, may monitor the first signaling broadcast by the next-generation LTE base station 10, read from the first signaling a PLMN list corresponding to a core network connection supporting capability of the UE, and determine whether to access the base station 10 based on a value of a cell-barred indicator bit of the PLMN list. As a result, UE supporting a 4G core network connection is prevented from trying to access a base station only supporting a 5G core network connection.

According to the embodiment, through the operations 101, 102, and 103, the UE can read the PLMN list and the cell-barred indicator bit corresponding to the PLMN list from the first signaling broadcast by the base station based on the supporting capability for core network connection, and then determine whether to access the PLMN in the PLMN list based on the value of the cell-barred indicator bit, wherein a plurality of PLMNs supporting different core network connections are recorded in different PLMN lists. For example, if UE only supports a 4G core network connection, the UE only reads a list of PLMNs supporting the 4G core network connections and determines whether to access the PLMNs in the read PLMN list according to a cell-barred indicator bit corresponding to the PLMN list. Therefore, the problem that UE only supporting the first core network connection attempts to access a base station only connected with the second core network connection in a scenario that a next-generation LTE base station is shared by multiple radio access networks is solved, which enables to minimize the problems of access failure, waste of signaling and increases of access delay caused by that the situation the UE only supporting the 4G core network connection attempts to access a PLMN only supporting a 5G core network connection.

Various embodiments of the present disclosure will be described below with specific implementations.

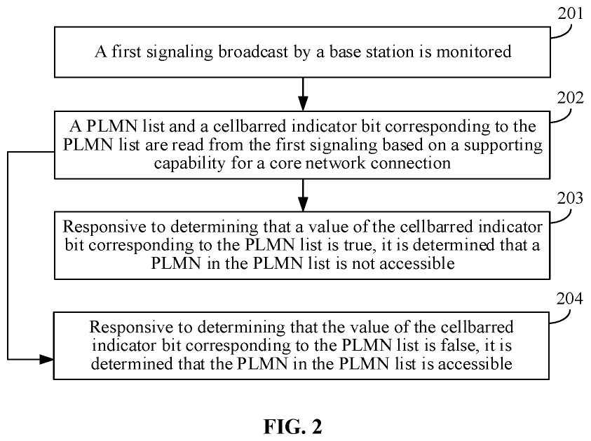

FIG. 2 is a flowchart illustrating another access method according to some embodiments of the present disclosure. The embodiment is exemplarily described with how UE determines a PLMN to be accessed based on first signaling as an example by use of the abovementioned method provided in the embodiments of the present disclosure. As shown in FIG. 2, the access method includes the following operations.

In operation 201, a first signaling broadcast by a base station is monitored.

In operation 202, a corresponding PLMN list and a cell-barred indicator bit corresponding to the PLMN list are read from the first signaling based on a supporting capability for core network connection, and then the operation of 203 or 204 is executed.

In an embodiment, descriptions about the operations 201 and 202 may refer to the descriptions about the operations 101 and 102 in the embodiment shown in FIG. 1A and will not be elaborated herein.

In operation 203, if a value of the cell-barred indicator bit corresponding to the PLMN list is true, it is determined that a PLMN in the PLMN list is accessible by the UE, and the flow is ended.

In an embodiment, if it is determined that the UE may only read the first list based on the core network connection supporting capability of the UE, and a value of a cell-barred indicator bit corresponding to the first list is true, the UE is not allowed to access the base station.

In an embodiment, it is determined based on the core network connection supporting capability of the UE that the UE may read both the first list and the second list, and the PLMN accessible by the UE is determined by the UE based on the value of the cell-barred indicator bit corresponding to the first list and a value of a cell-barred indicator bit corresponding to the second list. For example, the UE may access a PLMN in the first list if the value of the cell-barred indicator bit corresponding to the first list is false, and the UE may not access a PLMN in the second list if the value of the cell-barred indicator bit corresponding to the second list is true.

In an embodiment, after the PLMN accessible for the UE is determined by the UE, the UE may select the required PLMN to execute an access operation.

In operation 204, if the value of the cell-barred indicator bit corresponding to the PLMN list is false, it is determined that the PLMN in the PLMN list may be accessible by the UE.

In an embodiment, if it is determined based on the core network connection supporting capability of the UE that the UE may only read the first list, and the value of the cell-barred indicator bit corresponding to the first list is false, the base station allows the UE to access the PLMN in the PLMN list.

In the embodiment, the UE may determine whether to access the base station as well as the accessible PLMN based on the value of the cell-barred indicator bit of the read PLMN list, so that success rate of access of the UE to the network may be increased, and unnecessary signaling waste may be avoided.

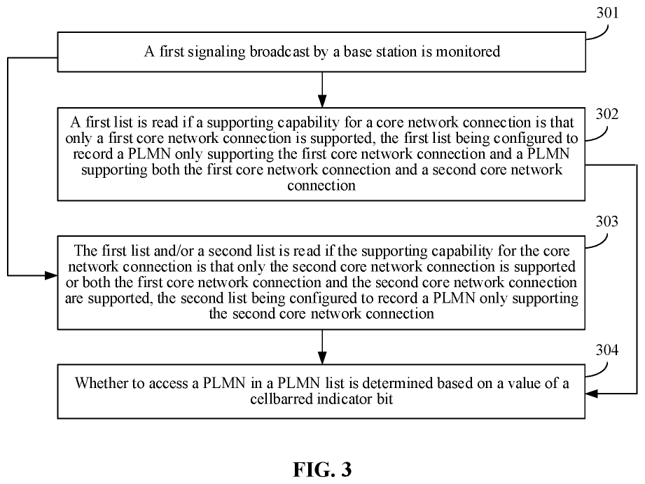

FIG. 3 is a flowchart illustrating another access method, according to some embodiments of the present disclosure. The embodiment is exemplarily described with how UE reads a PLMN list based on a supporting capability for core network connection as an example by use of the abovementioned method provided in the embodiments of the present disclosure. As shown in FIG. 3, the access method includes the following operations.

In operation 301, a first signaling broadcast by a base station is monitored, and the operation of 302 or 303 is executed.

In operation 302, a first list is read if a supporting capability for core network connection is that only a first core network connection is supported, the first list being configured to record a PLMN only supporting the first core network connection and a PLMN supporting both the first core network connection and a second core network connection, and the operation 304 is executed.

In operation 303, if the supporting capability for core network connection is that only the second core network connection is supported and/or both the first core network connection and the second core network connection are supported, the first list and/or a second list is read, the second list being configured to record a PLMN only supporting the second core network connection.

In operation 304, whether to access a PLMN in a PLMN list is determined based on a value of a cell-barred indicator bit.

In the embodiment, an implementation mode of the operation that the UE reads the PLMN list from the first signaling based on the supporting capability for core network connection is disclosed, which enables that UE only supporting a 4G core network connection may be prevented from reading a PLMN list formed by a PLMN only supporting a 5G core network connection, and thus the UE only supporting the 4G core network connection may further be prevented from accessing the PLMN only supporting the 5G core network connection.

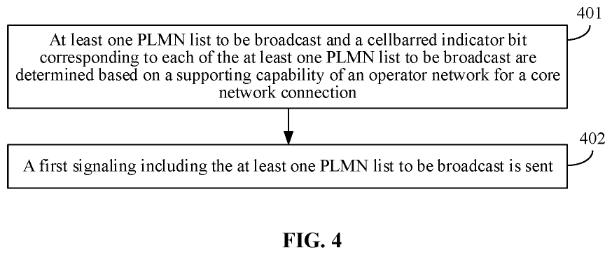

FIG. 4 is a flowchart illustrating an access method, according to some embodiments of the present disclosure. The access method may be applied to a base station. As shown in FIG. 4, the access method includes the following operations 401-402.

In operation 401, at least one PLMN list to be broadcast and a cell-barred indicator bit corresponding to each of the at least one PLMN list to be broadcast are determined based on a supporting capability of each operator network for core network connection.

In an embodiment, each operator network may be understood as an operator network of accessible by the base station.

In an embodiment, the at least one PLMN list to be broadcast includes a first list and/or a second list, the first list being configured to record a PLMN only supporting a first core network connection and a PLMN supporting both the first core network connection and a second core network connection, and the second list being configured to record a PLMN only supporting the second core network connection.

In an embodiment, the first core network connection may be a 4G network connection, and the second core network connection may be a 5G network connection.

In an embodiment, a value of the cell-barred indicator bit corresponding to each PLMN list may be determined by the base station based on a practical network condition.

In operation 402, a first signaling including the at least one PLMN list to be broadcast is sent.

In an embodiment, the first signaling may be a signaling formed by adding the PLMN list to be broadcast to the existing system signaling, for example, SIB1 signaling, and the first signaling may indicate the PLMN list, supporting the 5G core network connection, of the base station based on plmn-IdentityList-5GCN in the following codes, and indicate the cell-barred indicator bit of the PLMN list supporting the 5G core network connection based on cell-barred-5GCN.

| SystemInformationBlockType1 ::= | | SEQUENCE { |
|---|---|---|
| SIB1 system signaling | | |
| | cellAccessRelatedInfo | SEQUENCE { |

cell access related information

| | |
|---|---|
| PLMN-IdentityList | PLMN-IdentityList, |
| PLMN identity list | |
| trackingAreaCode | TrackingAreaCode, |

tracking area code

| | |
|---|---|
| cellIdentity | CellIdentity, |

cell identity information

| | |
|---|---|
| cellBarred | ENUMERATED {barred, notBarred}, |

cellbarred indication information

| | |
|---|---|
| intraFreqReselection | ENUMERATED{allowed, notAllowed}, |

co-frequency reselection

| | |
|---|---|
| csg-Indication | BOOLEAN, |

closed user group indication information

| | | |
|---|---|---|
| csg-Identity | CSG-Identity | OPTIONAL--Need OR |

closed user group identity

| | |
|---|---|
| plmn-IdentityList-5GCN | PLMN-IdentityList, |

PLMN list supporting 5G core network connection

| | |
|---|---|
| cellBarred-5GCN | ENUMERATED{barred, notBarred}, |

cellbarred indicator bit of PLMN list supporting 5G core network connection
}
}

In an exemplary scenario, as shown in FIG. 1B, a next-generation LTE base station LTE ng-eNB 10 and UE 30 are deployed in the scenario that the next-generation LTE base station is shared by multiple radio access networks. The next-generation LTE base station 10 is shared by multiple radio access networks, and may determine a PLMN list to be broadcast based on a supporting capability of each operator network for a core network connection and broadcast the PLMN list through a first signaling. The UE 20, after being turned on, may monitor the first signaling broadcast by the next-generation LTE base station 10, read from the first signaling a PLMN list corresponding to a supported core network connection capability, and determine whether to access the base station 10 based on a value of a cell-barred indicator bit of the PLMN list. Therefore, UE supporting a 4G core network connection is prevented from trying to access a base station only supporting a 5G core network connection.

According to the embodiment, through the operations of 401 to 402, the base station may broadcast different PLMN lists and the cell-barred indicator bit corresponding to each of the different PLMN list in the first signaling based on the core network connection supporting capability of each operator network (i.e., the supporting capability that the operator network supports the core network connection), so that the UE may determine an accessible PLMN after monitoring the broadcast first signaling, and initiate an access operation to the accessible PLMN so as to avoid an access failure as much as possible.

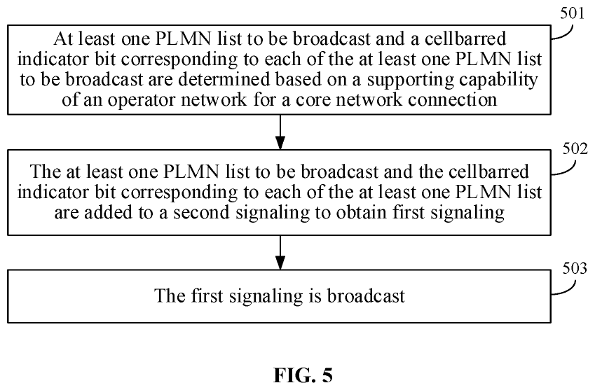

FIG. 5 is a flowchart illustrating another access method according to some embodiments of the present disclosure. The embodiment is exemplarily described with how a base station generates a first signaling as an example by use of the abovementioned method provided in the embodiments of the present disclosure. As shown in FIG. 5, the access method includes the following operations.

In operation 501, one or more PLMN lists to be broadcast and a cell-barred indicator bit corresponding to each of the one or more PLMN lists to be broadcast are determined based on a supporting capability of each operator network for a core network connection.

In an embodiment, the supporting capability of each operator network for the core network connection may be set in advance by its respective operator during construction of the base station. That is, the supporting capability of each operator network for the core network connection has been preset during construction of the base station. For example, information such as a network of operator 1 only supporting connection to a 4G core network, a network of operator 2 only supporting connection to a 5G core network and a network of operator 3 supporting connection to both the 4G and 5G core networks is set in advance by the respective operator based on their own core network connection supporting capabilities.

In an embodiment, the network operator may set a value of the corresponding cell-barred indicator bit through an Operation Administration and Maintenance (OAM) system. For example, the network of operator 3 supports connection to both the 4G and 5G core networks, but it tends to serve more the UE that only supports connection to the 5G core network. In this regard, a barred indicator bit corresponding to a first list (in which a PLMN only supporting a first core network connection and a PLMN supporting both the first core network connection and a second core network connection are recorded) in the PLMN list to be broadcast may be set to be true, so as to prevent the UE supporting the 5G core network from accessing a PLMN in a second list rather than the PLMN in the first list.

In an embodiment, descriptions about the operation 501 may refer to the descriptions about the operation 401 in the embodiment shown in FIG. 4 and will not elaborated herein.

In operation 502, the at least one PLMN list to be broadcast and the cell-barred indicator bit corresponding to each of the at least one PLMN list are added to a second signaling to obtain the first signaling.

In an embodiment, the second signaling may be an existing system signaling, for example, SIB1 signaling, and the first signaling may be obtained by adding the PLMN list to be broadcast and its corresponding cell-barred indicator bit to the second signaling. For example, plmn-IdentityList-5GCN information is added to the SIB1 signaling to indicate a PLMN list, supporting a 5G core network connection, of the base station, and cell-barred-5GCN information is added to the SIB1 signaling to indicate a cell-barred indicator bit corresponding to the PLMN list, supporting the 5G core network connection, of the base station.

In operation 503, the first signaling is broadcast by the base station.

In the embodiment, an implementation mode of generating the first signaling is disclosed, and the PLMN list to be broadcast and its corresponding cell-barred indicator bit may be added to the second signaling to obtain the first signaling, of which the implementation mode is relatively simple and flexible.

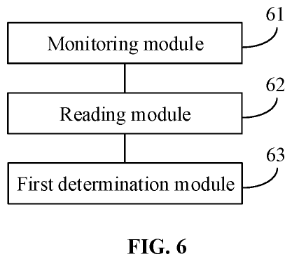

FIG. 6 is a block diagram of an access device according to some embodiments of the present disclosure. The access device is applied to UE, and as shown in FIG. 6, includes:
a monitoring module 61, configured to monitor a first signaling broadcast by a base station;
a reading module 62, configured to read a PLMN list and a cell-barred indicator bit corresponding to the PLMN list from the first signaling monitored by the monitoring module 61 based on a supporting capability for a core network connection; and
a first determination module 63, configured to determine whether to access a PLMN in the PLMN list based on a value of the cell-barred indicator bit read by the reading module 62.

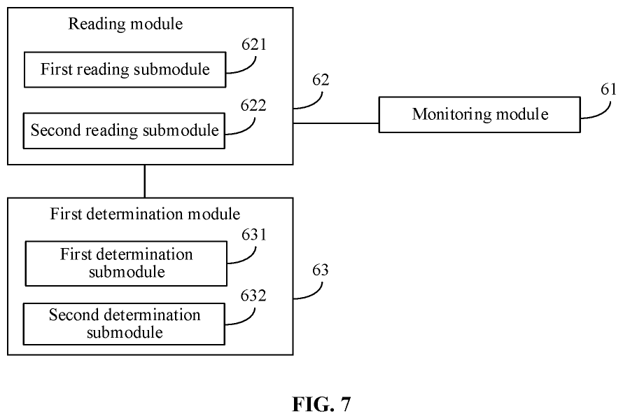

FIG. 7 is a block diagram of another access device, according to some embodiments of the present disclosure. As shown in FIG. 7, based on the embodiment shown in FIG. 6, in an embodiment, the reading module 62 includes:
a first reading submodule 621, configured to read a first list if the supporting capability for the core network connection is that only a first core network connection is supported, the first list being configured to record a PLMN only supporting the first core network connection; and
a second reading submodule 622, configured to read the first list and/or a second list if the supporting capability for core network connection is that only the second core network connection is supported and/or both the first core network connection and the second core network connection are supported, the second list be configured to record a PLMN only supporting the second core network connection and a PLMN supporting both the first core network connection and the second core network connection.

In an embodiment, the first determination module 63 includes:
a first determination submodule 631, configured to determine that the PLMN in the PLMN list is not accessible by the UE in response to the value of the cell-barred indicator bit corresponding to the PLMN list being true; and
a second determination submodule 632, configured to determine that the PLMN in the PLMN list is accessible by the UE in response to the value of the cell-barred indicator bit corresponding to the PLMN list being false.

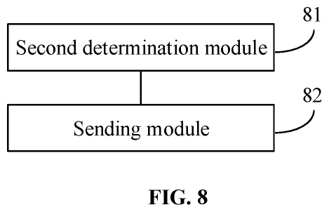

FIG. 8 is a block diagram of an access device according to some embodiments of the disclosure. The access device is applied to a base station, and as shown in FIG. 8, includes:
a second determination module 81, configured to determine one or more PLMN lists to be broadcast and a cell-barred indicator bit corresponding to each of the one or more PLMN lists to be broadcast based on a supporting capability of each operator for a core network connection; and
a sending module 82, configured to send a first signaling including the at least one PLMN list to be broadcast.

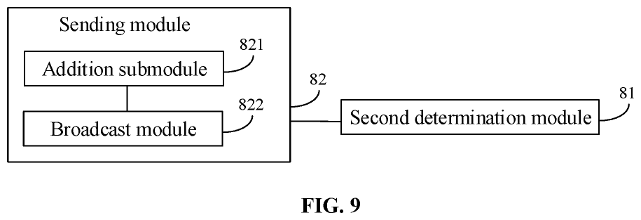

FIG. 9 is a block diagram of another access device according to some embodiments of the present disclosure. As shown in FIG. 9, based on the embodiment shown in FIG. 8, in an embodiment, the one or more PLMN lists to be broadcast includes a first list and/or a second list, the first list being configured to record a PLMN only supporting a first core network connection, and the second list being configured to record a PLMN only supporting a second core network connection and a PLMN supporting both the first core network connection and the second core network connection.

In an embodiment, the sending module 82 includes:
an addition submodule 821, configured to add the at least one PLMN list to be broadcast and the cell-barred indicator bit corresponding to each of the at least one PLMN list into a second signaling to obtain the first signaling; and
a broadcast submodule 822, configured to broadcast the first signaling.

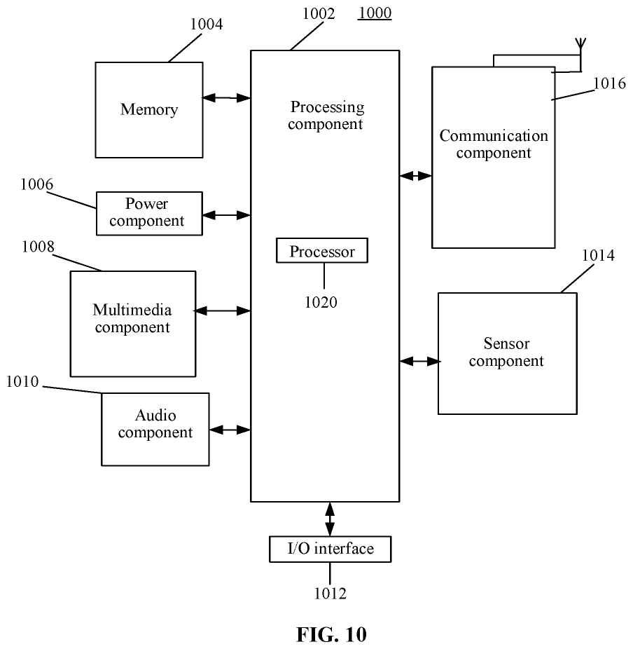

FIG. 10 is a block diagram of an access device according to some embodiments of the present disclosure. For example, the device 1000 may be UE such as a mobile phone, a computer, a digital broadcast terminal, a messaging device, a gaming console, a tablet, a medical device, exercise equipment and a personal digital assistant.

Referring to FIG. 10, the device 1000 may include one or more of the following components: a processing component 1002, a memory 1004, a power component 1006, a multimedia component 1008, an audio component 1010, an Input/Output (I/O) interface 1012, a sensor component 1014, or a communication component 1016.

The processing component 1002 typically controls overall operations of the device 1000, such as the operations associated with display, telephone calls, data communications, camera operations, and recording operations. The processing component 1002 may include one or more processors 1020 to execute instructions to perform all or part of the steps in the abovementioned method. Moreover, the processing component 1002 may include one or more modules which facilitate interaction between the processing component 1002 and the other components. For instance, the processing component 1002 may include a multimedia module to facilitate interaction between the multimedia component 1008 and the processing component 1002.

The memory 1004 is configured to store various types of data to support the operation of the device 1000. Examples of such data include instructions for any application programs or methods operated on the device 1000, contact data, phonebook data, messages, pictures, video, etc. The memory 1004 may be implemented by any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, and a magnetic or optical disk.

The power component 1006 provides power for various components of the device 1000. The power component 1006 may include a power management system, one or more power supplies, and other components associated with generation, management and distribution of power for the device 1000.

The multimedia component 1008 includes a screen providing an output interface between the device 1000 and a user. In some embodiments, the screen may include a Liquid Crystal Display (LCD) and a Touch Panel (TP). In some embodiments, organic light-emitting diode (OLED) or other types of displays can be employed.

If the screen includes the TP, the screen may be implemented as a touch screen to receive an input signal from the user. The TP includes one or more touch sensors to sense touches, swipes and gestures on the TP. The touch sensors may not only sense a boundary of a touch or swipe action but also detect a duration and pressure associated with the touch or swipe action. In some embodiments, the multimedia component 1008 includes a front camera and/or a rear camera. The front camera and/or the rear camera may receive external multimedia data when the device 1000 is in an operation mode, such as a photographing mode or a video mode. Each of the front camera and the rear camera may be a fixed optical lens system or have focusing and optical zooming capabilities.

The audio component 1010 is configured to output and/or input an audio signal. For example, the audio component 1010 includes a Microphone (MIC), and the MIC is configured to receive an external audio signal when the device 1000 is in the operation mode, such as a call mode, a recording mode and a voice recognition mode. The received audio signal may further be stored in the memory 1004 or sent through the communication component 1016. In some embodiments, the audio component 1010 further includes a speaker configured to output the audio signal.

The I/O interface 1012 provides an interface between the processing component 1002 and a peripheral interface module, and the peripheral interface module may be a keyboard, a click wheel, a button and the like. The button may include, but not limited to: a home button, a volume button, a starting button and a locking button.

The sensor component 1014 includes one or more sensors configured to provide status assessment in various aspects for the device 1000. For instance, the sensor component 1014 may detect an on/off status of the device 1000 and relative positioning of components, such as a display and small keyboard of the device 1000, and the sensor component 1014 may further detect a change in a position of the device 1000 or a component of the device 1000, presence or absence of contact between the user and the device 1000, orientation or acceleration/deceleration of the device 1000 and a change in temperature of the device 1000. The sensor component 1014 may include a proximity sensor configured to detect presence of an object nearby without any physical contact. The sensor component 1014 may also include a light sensor, such as a Complementary Metal Oxide Semiconductor (CMOS) or Charge Coupled Device (CCD) image sensor, configured for use in an imaging application. In some embodiments, the sensor component 1014 may also include an acceleration sensor, a gyroscope sensor, a magnetic sensor, a pressure sensor or a temperature sensor.

The communication component 1016 is configured to facilitate wired or wireless communication between the device 1000 and another device. The device 1000 may access a communication-standard-based wireless network, such as a Wireless Fidelity (Wi-Fi) network, a 2nd-Generation (2G), 3rd-Generation (3G), 4G, or 5G network or a combination thereof In an exemplary embodiment, the communication component 1016 receives a broadcast signal or broadcast associated information from an external broadcast management system through a broadcast channel. In an exemplary embodiment, the communication component 1016 further includes a Near Field Communication (NFC) module to facilitate short-range communication. For example, the NFC module may be implemented based on a Radio Frequency Identification (RFID) technology, an Infrared Data Association (IrDA) technology, an Ultra-Wide Band (UWB) technology, a Bluetooth (BT) technology and another technology.

In some embodiments, the device 1000 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

In some embodiments, there is also provided a non-transitory computer-readable storage medium including instructions, such as the memory 1004 including instructions, and the instructions may be executed by the processor 1020 of the device 1000 to execute the method described in the first aspect: a first signaling broadcast by a base station is monitored; a PLMN list and a cell-barred indicator bit corresponding to the PLMN list is read from the first signaling based on a supporting capability for a core network connection; and whether to access a PLMN in the PLMN list is determined based on a value of the cell-barred indicator bit.

In an embodiment, the non-transitory computer-readable storage medium may be a ROM, a Random Access Memory (RAM), a Compact Disc Read-Only Memory (CD-ROM), a magnetic tape, a floppy disc, an optical data storage device and the like.

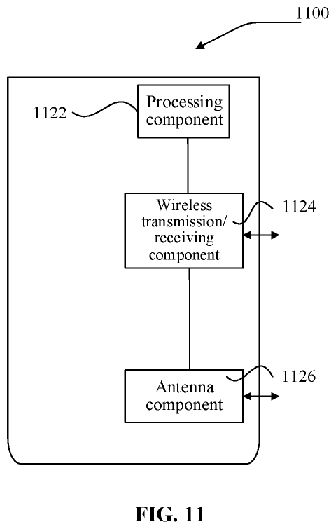

FIG. 11 is a block diagram of a data sending device according to some embodiments of the present disclosure. The device 1100 may be provided as a base station. Referring to FIG. 11, the device 1100 includes a processing component 1122, a wireless transmission/receiving component 1124, an antenna component 1126 and a wireless interface-specific signal processing part, and the processing component 1122 may further include one or more processors.

One of the processors in the processing component 1122 may be configured to execute the access method described in the second aspect.

In an exemplary embodiment, there is also provided a non-transitory computer-readable storage medium including instructions, and the instructions may be executed by the processing component 1122 of the device 1100 to execute the method described in the second aspect: at least one PLMN list to be broadcast and a cell-barred indicator bit corresponding to each of the at least one PLMN list to be broadcast is determined based on a supporting capability of each operator network for a core network connection; and a first signaling including the at least one PLMN list to be broadcast is sent.

In an embodiment, the non-transitory computer-readable storage medium may be a ROM, a RAM, a CD-ROM, a magnetic tape, a floppy disc, an optical data storage device and the like.

The various device components, modules, units, blocks, or portions may have modular configurations, or are composed of discrete components, but nonetheless can be referred to as “modules” in general. In other words, the “components,” “modules,” “blocks,” “portions,” or “units” referred to herein may or may not be in modular forms.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “I” generally indicates that the contextual objects are in an “or” relationship.

In the present disclosure, it is to be understood that the terms “lower,” “upper,” “under” or “beneath” or “underneath,” “above,” “front,” “back,” “left,” “right,” “top,” “bottom,” “inner,” “outer,” “horizontal,” “vertical,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

Moreover, the terms “first” and “second” are used for descriptive purposes only and are not to be construed as indicating or implying a relative importance or implicitly indicating the number of technical features indicated. Thus, elements referred to as “first” and “second” may include one or more of the features either explicitly or implicitly. In the description of the present disclosure, “a plurality” indicates two or more unless specifically defined otherwise.

In the present disclosure, a first element being “on” a second element may indicate direct contact between the first and second elements, without contact, or indirect geometrical relationship through one or more intermediate media or layers, unless otherwise explicitly stated and defined. Similarly, a first element being “under,” “underneath” or “beneath” a second element may indicate direct contact between the first and second elements, without contact, or indirect geometrical relationship through one or more intermediate media or layers, unless otherwise explicitly stated and defined.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

1. An access method, applied to User Equipment (UE) and comprising:
monitoring a first signaling broadcast by a base station;
reading, based on a supporting capability for core network connection, from the first signaling a Public Land Mobile Network (PLMN) list and a cell-barred indicator bit corresponding to the PLMN list; and
determining, based on a value of the cell-barred indicator bit, whether to access a PLMN in the PLMN list.

2. The method of claim 1, wherein the reading, based on the supporting capability for core network connection, from the first signaling the corresponding PLMN list and the cell-barred indicator bit corresponding to the PLMN list comprises:
reading a first list if the supporting capability for the core network connection is that only a first core network connection is supported, wherein the first list is configured to record a PLMN only supporting the first core network connection and a PLMN supporting both the first core network connection and a second core network connection.

3. The method of claim 1, wherein the reading, based on the supporting capability for core network connection, from the first signaling the corresponding PLMN list and the cell-barred indicator bit corresponding to the PLMN list comprises:
reading at least one of the first list or a second list if the supporting capability for the core network connection is that only the second core network connection is supported or both the first core network connection and the second core network connection are supported, wherein the second list is configured to record a PLMN only supporting the second core network connection.

4. The method of claim 1, wherein the determining, based on the value of the cell-barred indicator bit, whether to access the PLMN in the PLMN list comprises:
if the value of the cell-barred indicator bit corresponding to the PLMN list is true, determining that the PLMN in the PLMN list is not accessible;
if the value of the cell-barred indicator bit corresponding to the PLMN list is false, determining that the PLMN in the PLMN list is accessible.

5. The method of claim 1, wherein the first signaling comprises at least one PLMN list comprising at least one of a first list or a second list, and
the first signaling is obtained by adding the at least one PLMN list to be broadcast and the cell-barred indicator bit corresponding to each of the at least one PLMN list to be broadcast into a second signaling.

6. An access method, applied to a base station and comprising:
determining at least one Public Land Mobile Network (PLMN) list to be broadcast and a cell-barred indicator bit corresponding to each of the at least one PLMN list to be broadcast based on a supporting capability of each operator network for core network connection; and
sending a first signaling comprising the at least one PLMN list to be broadcast.

7. The method of claim 6, wherein the at least one PLMN list to be broadcast comprises at least one of a first list or a second list, the first list being configured to record a PLMN only supporting a first core network connection and a PLMN supporting both the first core network connection and a second core network connection, and the second list being configured to record a PLMN only supporting the second core network connection.

8. The method of claim 6, wherein the sending the first signaling comprising the at least one PLMN list to be broadcast comprises:
adding the at least one PLMN list to be broadcast and the cell-barred indicator bit corresponding to each of the at least one PLMN list to be broadcast into a second signaling to obtain the first signaling; and
broadcasting the first signaling.

9. User Equipment (UE), comprising:
a processor; and
memory storing instructions for execution by the processor to:
monitor a first signaling broadcast by a base station;
read, based on supporting capability for core network connection, a Public Land Mobile Network (PLMN) list and a cell-barred indicator bit corresponding to the PLMN list from the first signaling; and
determine whether to access a PLMN in the PLMN list based on a value of the cell-barred indicator bit read.

10. The UE of claim 9, wherein the processor is further configured to:
read a first list if the supporting capability for core network connection is that only a first core network connection is supported, wherein the first list is configured to record a PLMN only supporting the first core network connection.

11. The UE of claim 9, wherein the processor is further configured to:
read at least one of the first list or a second list if the supporting capability for core network connection is that only a second core network connection is supported or both the first core network connection and the second core network connection are supported, wherein the second list is configured to record a PLMN only supporting the second core network connection and a PLMN supporting both the first core network connection and the second core network connection.

12. The UE of claim 9, wherein the processor is further configured to:
determine that the PLMN in the PLMN list is not accessible if the value of the cell-barred indicator bit corresponding to the PLMN list is true; and
determine that the PLMN in the PLMN list is accessible if the value of the cell-barred indicator bit corresponding to the PLMN list is false.

13. The UE of claim 9, wherein the first signaling comprises at least one PLMN list comprising at least one of a first list or a second list, and
the first signaling is obtained by adding the at least one PLMN list to be broadcast and the cell-barred indicator bit corresponding to each of the at least one PLMN list to be broadcast into a second signaling.

14. Abase station, comprising:
a processor; and
a memory configured to store instructions executable by the processor;
wherein the processor is configured to:
determine, based on a supporting capability of each operator network for core network connection, at least one Public Land Mobile Network (PLMN) list to be broadcast and a cell-barred indicator bit corresponding to each of the at least one PLMN list to be broadcast; and
send a first signaling comprising the at least one PLMN list to be broadcast.

15. The base station of claim 14, wherein the at least one PLMN list to be broadcast comprises at least one of a first list or a second list, the first list being configured to record a PLMN only supporting a first core network connection, and the second list being configured to record a PLMN only supporting a second core network connection and a PLMN supporting both the first core network connection and the second core network connection.

16. The base station of claim 14, wherein the processor is further configured to:
add the at least one PLMN list to be broadcast and the cell-barred indicator bit corresponding to each of the at least one PLMN list to be broadcast into a second signaling to obtain the first signaling; and
broadcast the first signaling.

17. A communication system implementing the method of claim 1, comprising the UE, wherein the UE only supports a first core network connection.

18. The communication system of claim 17, further comprising a base station, wherein the base station is connected with the first core network and a second core network connection.

19. The communication system of claim 18, wherein a plurality of PLMNs supporting different core network connections are recorded in different PLMN lists; and wherein the UE is configured to only read a list of PLMNs supporting the first core network connection and determine whether to access the PLMNs in the read PLMN list according to a cell-barred indicator bit corresponding to the PLMN list.

20. The communication system of claim 19, wherein the first core network connection is a 4G core network, and the second core network connection is a 5G core network connection;
and wherein the UE is prevented from attempting to access a PLMN only supporting the 5G core network connection, thereby reducing waste of signaling and access delay.
